(19) United States
(12) Patent Application Publication
(10) Pub. No.: US 2007/0220260 A1
(43) Pub. Date: Sep. 20, 2007

(54) Protecting the integrity of electronically derivative works

(75) Inventor: James C. King, Santa Cruz, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Adobe Systems Incorporated

(21) Appl. No.: 11/375,807

(22) Filed: Mar. 14, 2006

(51) Int. Cl. H04L 9/00

(52) U.S. Cl. 713/176

(57) ABSTRACT

Systems and methods provide a mechanism to protect the integrity of electronically derivative works. One aspect of the systems and methods includes receiving an original document including a first digital signature. After the document is derived, a second digital signature is created. The second digital signature may include the first digital signature, a message digest from the first digital signature, and a message digest for the second digital signature. A further aspect of the systems and methods include assigning a security key to a document processing application. The assigned key may be used to produce the second document signature.

### FIELD

The embodiments relate generally to processing electronic works such as documents, and more particularly to protecting and verifying the integrity of electronic works.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

From the very beginning of written expression, documents have been an important part of many business, political and personal transactions. Technology advances have led to improved methods of document processing. For example, the application of computer systems to document processing has made document creation, editing, management and distribution easier than ever before. For example, a forms package may be electronically created, edited, and distributed.

It is often important to be able to determine if a document has been altered since it was created. For paper documents, one way this can be accomplished is to compare paper versions of the document. However, this may be impossible for electronic documents. For electronic documents, digital signatures are becoming acceptable as a means to detect alteration of documents. Various forms of digital signatures exist. A typical digital signature includes an encrypted message digest that is computed using a hashing function applied to the document contents. A party wishing to verify the integrity of the document decrypts the signature to obtain the message digest, recomputes the hash-value using the same hashing function that was used to create the original message digest value, and compares the hash-value to the message digest value. If the values are the same, the document has not been altered. If they are different, it is likely the document has been altered.

Today, a document may be part of a workflow in which the document may be handled and updated by multiple parties. In current systems, only one digital signature typically may be used to protect the integrity of the document. Subsequent authorized updates to the document result in the replacement of the digital signature with a new digital signature.

Consider the hypothetical situation of a bank that provides online mortgage services to customers. The bank may create electronic document packages containing interactive forms that a borrower must fill out in order to apply for a mortgage. After the user fills out the interactive forms by providing data in the fields in the form, the completed electronic document package may be submitted to the bank. The bank, upon receiving the electronic document package may read the data in the forms, perform a credit analysis based on the information provided, and add the results of the credit analysis to the electronic document package. The package may then be sent to the bank's underwriting department for approval.

At various points in the workflow illustrated above, it may be desirable to insure that the documents are not altered in an unauthorized manner. For example, the borrower may want to verify that the documents received from the bank are valid documents that have not been altered from the time they were created to when the borrower receives them. It is desirable for the bank to know that the original document text was not altered by the borrower, and that any form field data provided by the borrower was not altered in between the time the borrower electronically sends the document and when the bank receives it. The bank's underwriting department may want to know that the original document was not altered, that the data provided by the borrower on the form was not altered, and that the results of the credit analysis have not been altered. As noted above, in previous systems, only the most immediate version of the document typically may be protected against modification. Thus in previous system's handling of the situation above, the bank, upon receiving the document may be able to detect that the document was not altered after the borrower sends it, but would not be able to detect if the borrower had altered the original document. Similarly, the bank's underwriting department may be able detect that the document was not altered after the credit analysis was added, but would not be able to detect whether or not the original document or form data had been altered prior to the credit analysis.

### SUMMARY

Systems and methods provide a mechanism to protect the integrity of electronically derivative documents. One aspect of the systems and methods includes receiving a message digest for a first document. The first message digest may be included in a first digital signature. A second digital signature is created for a derived document. The second digital signature may include the first message digest, a reference to the previous or original document and a message digest for the second digital signature. Further document derivations may result in further digital signatures being created to protect the integrity of the derived document, where each further digital signature includes previously created digital signatures.

A further aspect of the systems and methods include assigning a security key to a document processing application. The assigned key may be used to produce the second document signature. The document processing application may verify the integrity of each previous version of the document by decrypting one or more previous digital signatures and comparing a message digest in each digital signature with an associated previous version of the document. The system may then replace the previous digital signatures with a digital signature created using the assigned security key.

The present application describes systems, methods, and computer-readable media of varying scope. In addition to the aspects and advantages described in this summary, further aspects and advantages will become apparent by reference to the drawings and by reading the detailed description that follows.

### BRIEF DESCRIPTION OF THE DRAWINGS

FIGS. 1A and 1B are a block diagrams illustrating example elements of document processing workflows incorporating embodiments of the invention.

FIG. 2 is a block diagram illustrating major logical components of a document processing system according to example embodiments of the invention.

FIG. 3A is a block diagram illustrating elements of a document file structure used in example embodiments of the invention.

FIG. 3B is a block diagram illustrating elements of a document file structure following a document update used in example embodiments of the invention.

FIG. 3C is a block diagram illustrating elements of a document file and digital signature structure according to example embodiments of the invention.

FIG. 3D is a block diagram illustrating elements of a document file and digital signature structure according to alternative example embodiments of the invention.

FIG. 4A is a block diagram illustrating a digital signature according to an example embodiment.

FIG. 4B is a block diagram illustrating a digital signature for a derivative document according to an example embodiment.

FIG. 4C is a block diagram illustrating a digital signature for a derivative document according to an alternative example embodiment.

FIG. 5 is a flowchart illustrating a method for creating a digital signature according to embodiments of the invention.

FIG. 6 is a flowchart illustrating a method for validating the integrity of a document according to embodiments of the invention.

FIG. 7 is a block diagram illustrating components of a computing device that may execute systems and methods according to embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions that follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

In general, the various embodiments of the invention operate on documents that have been derived from previous documents. A document may be considered to be derived from a previous document if it would not exist in the absence of the previous document. A document may be logically derived or physically derived from a previous document. A physically derived document is one in which the content of the derived document comprises an updated or modified version of the previous document.

A logically derived document is one in which the content of the previous document and the derived document are logically related, but the derived document is not an update or modification of the original document. In other words, the derived document is a work that is informed by the previous work but isn't necessarily a modification of it. Thus the previous and derived documents are related to each other in that the derived document could not have been created without the first one existing and is thus logically related to the previous version. As an example, consider a document that is a critique of a previous document. The critique is not a modification of the previous document, however it is logically related to the previous document in that the critique would not exist unless the previous document existed.

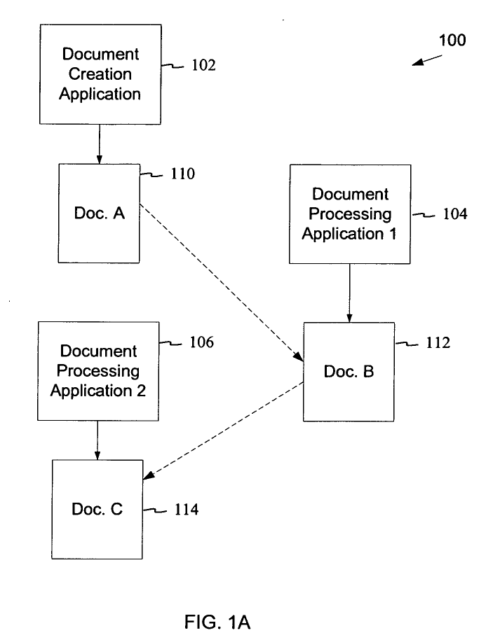

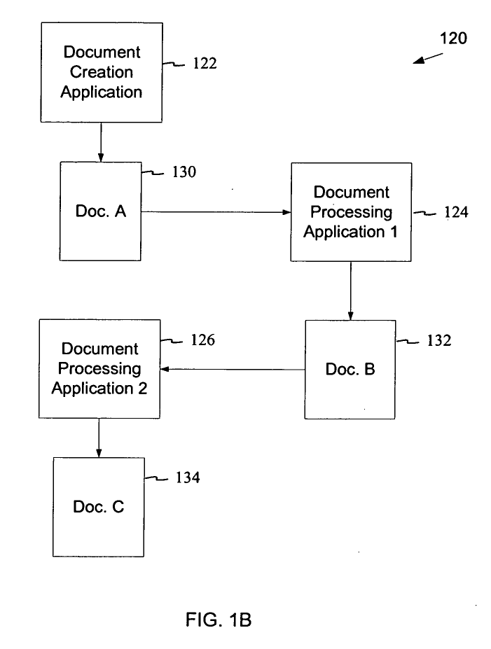

FIG. 1A is a block diagram illustrating example elements of a document processing workflow 100 incorporating embodiments of the invention that operate to create logically derived documents. In the example shown, the workflow includes a document creation application 102, a first document processing application 104, and a second document processing application 106. Applications 102, 104 and 106 in workflow 100 may be on the same computing system or network, or they may be distributed in various fashions across multiple computing systems and/or networks.

Document creation application 102 creates an initial document “A” 110. In some embodiments, the document creation application 102 may be an application from the Adobe Acrobat® family of document processing application available from Adobe Systems Inc. of San Jose, Calif. However, the embodiments are not limited to any particular document creation application and in alternative embodiments the document creation application may be a word processing application, an image processing application, or other application that operates on electronic works. As an example, desktop application 102 may comprise the Microsoft® Word application available from Microsoft Corporation of Redmond, Wash., or the WordPerfect® word processing application available from Corel Corporation of Ottawa, Ontario Canada.

Like document creation application 102, first document processing application 104 may be a document processing application from the Adobe Acrobat family of applications, the Microsoft Word application, or the WordPerfect word processing application. First document processing application may refer to document A 110 to produce document B 112. As an example, a user of document creation application 102 may generate document A 110 that is an application for a loan. First document processing application 104 may use the data provided in document A 110 to generate document B 112, an offer for a loan that contains the terms of the loan. The logical relationship between the documents is indicated by the dashed line connecting document A 110 to document B 112. It should be noted that first document processing application 104 may be an automated document processing application that reads an input document such as document A 110 and produces document B 112 based on the content of document A 110. Thus in this example, the terms of the loan offer generated in document B 112 may be based in part on information that is read from document A 110.

Second document processing application 106 may then refer to document B 112, and generate document C 114. To continue with the loan example above, document C 114 may be a form indicating acceptance of the loan offer.

FIG. 1B is a block diagram illustrating example elements of a document processing workflow 120 incorporating embodiments of the invention that operate to create physically derived documents. In the example shown, the workflow includes a document creation application 122, a first document processing application 124, and a second document processing application 126. Applications 122, 124 and 126 in workflow 120 may be on the same computing system or network, or they may be distributed in various fashions across multiple computing systems and/or networks.

Document creation application 122 creates an initial document “A” 130. In some embodiments, the document creation application 122 may be an application from the Adobe Acrobat® family of document processing application available from Adobe Systems Inc. of San Jose, Calif. However, the embodiments are not limited to any particular document creation application and in alternative embodiments the document creation application may be a word processing application, an image processing application, or other application that operates on electronic works. As an example, desktop application 102 may comprise the Microsoft® Word application available from Microsoft Corporation of Redmond, Wash., or the WordPerfect® word processing application available from Corel Corporation of Ottawa, Ontario Canada.

First document processing application 124 receives document A 130 after it has been created. Like document creation application 122, first document processing application 124 may be a document processing application from the Adobe Acrobat family of applications, the Microsoft Word application, or the WordPerfect word processing application. Application 124 receives document A 130 after it has been created by application 122. During the operation of document processing application 124, changes to document A 130 may be made resulting in document “B” 132. For example, a user of application 124 may provide data in fields of a form portion of document A 130. Additionally, a user of application 124 may edit text or graphics in document A 130. Further, a user may add annotations or comments to document A 130. Any or all of these changes may be made part of document B 132.

Second document processing application 126 may then receive document B 132, and make further changes to the document. For example, a user of document application 126 may provide further data in a forms portion, additional changes to text or graphics, or additional comments. Alternatively, document processing application 126 may be an application designed to run without significant user control. For example, document processing application 126 may be designed to automatically receive a document and prepare it for automated distribution or publication by flattening any form data found in the document. Flattening is a process in which an interactive form in a document is converted to a non-interactive form and any data previously provided for the interactive form is converted to text and placed in the appropriate field. For example, a form having one or more data input fields may be completed by a user, and further edits of the form fields may no longer be desired or allowed. The form may be flattened by converting the form so that input is no longer allowed and any data in the form is converted to appear as text in the form field.

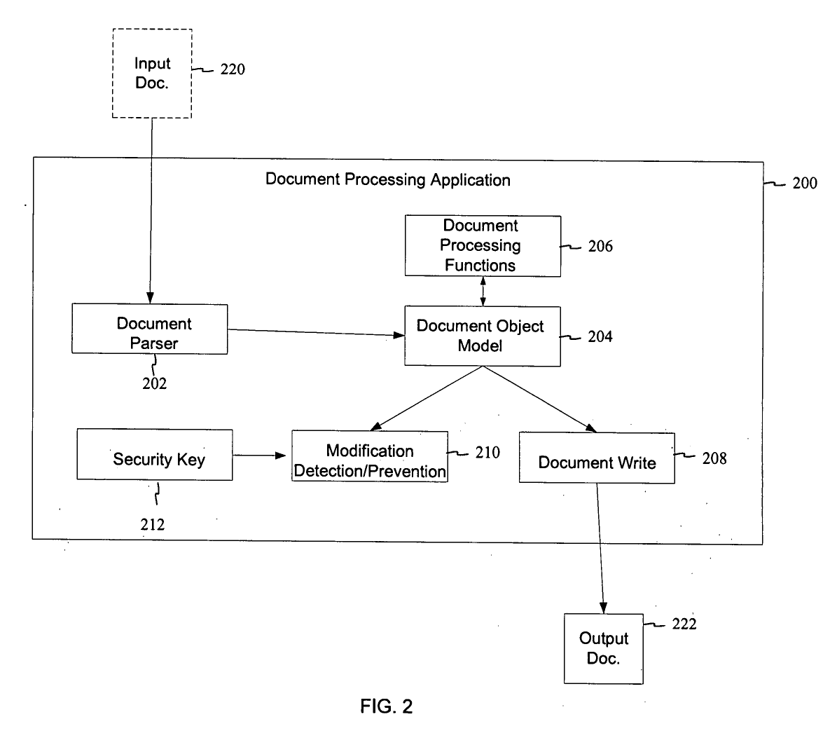

FIG. 2 is a block diagram illustrating major logical components of a document processing application 200 according to example embodiments of the invention. In some embodiments, application 200 includes a document parser 202, document processing functions 206, modification detection/protection component 210 and document write component 208.

Document parser 202 optionally reads an input document 220, and parses the structure and elements found in the input document 220 into a document object model 204. Document object model 204 comprises a set of data structures that include components that describe the format and content of the document. Examples of such components include font specifiers, text content, graphical images, form definitions, and positional information that define how a document is to be presented to a user. In cases where output document 222 is a logically derived document, an input document 220 may not be utilized. It should be noted that the embodiments do not require a document object model and that a document may be parsed into a memory by any mechanism know in the art.

Document processing functions 206 provide an interface and mechanism to create and modify a document represented by the document object model 204. As changes are made by the user, the objects in the document object model are updated and new objects may be added. In some embodiments, document processing functions 206 may provide limited capability to modify an input document. For example, the functions may be limited to adding data for form fields present in the document.

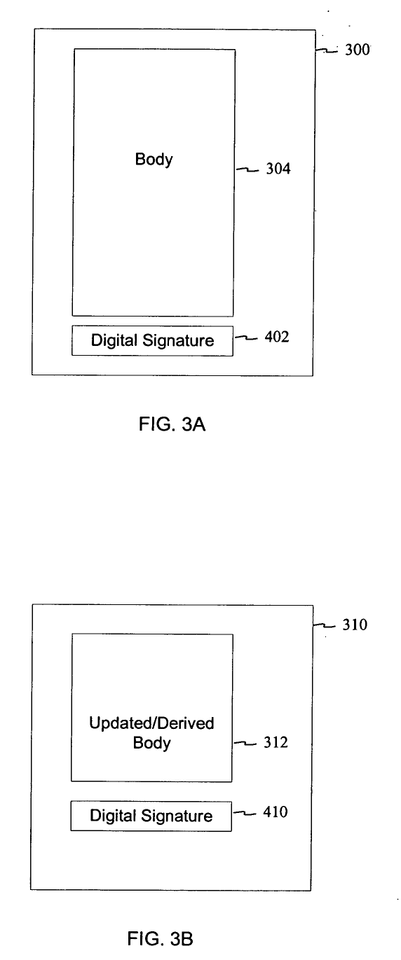

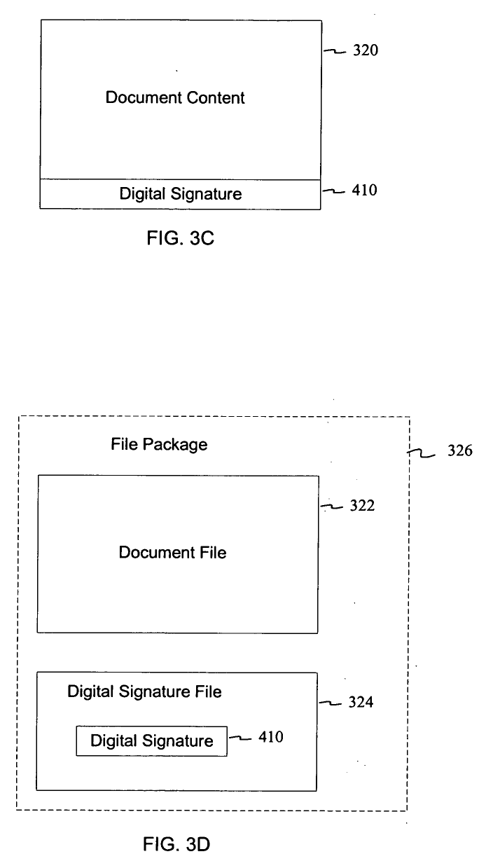

Document write component 208 reads the document object model 204 and writes an updated document file 222. Further details on the format of document files 220 and 222 are provided below with reference to FIGS. 3A and 3B.

In some embodiments, application 200 includes a modification detection/prevention (MDP) component 210. Input document 220 may include a digital signature that aids in detecting whether a document has been altered after it was digitally signed. If such a signature is present, MDP component 210 includes functions that processes a digital signature and use the signature to determine if the input document was altered. In some embodiments, a security key 212 is provided to decrypt a signature in the document to obtain a message digest that is generated based on the document contents. In this case, the security key may be a public key of a public/private key infrastructure.

In addition, MDP component 210 may include functions that create a digital signature for use in protecting output document 222. In this case, security key 212 may be a private key of a public/private key pair and is used to encrypt the contents of the digital signature. MDP component 210 reads the security key and uses it to encrypt a message digest that is computed based on the contents of the output document 222. In some embodiments, security key 212 may be a personal security key assigned to a particular user. In alternative embodiments, security key 212 may be a key that is assigned to the particular document processing application.

Security key 212 may be a public or private key of a public/private key pair, it may be a password, or it may be a biometric key such as a finger print. The embodiments of the invention are not limited to any particular type of security key.

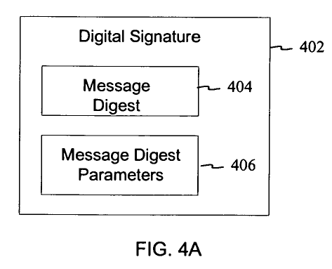

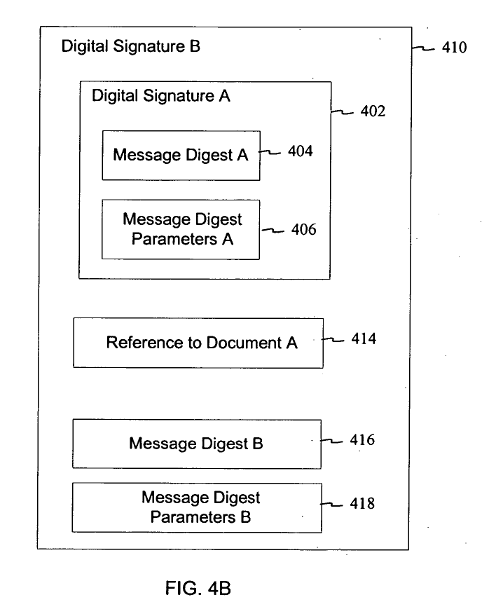

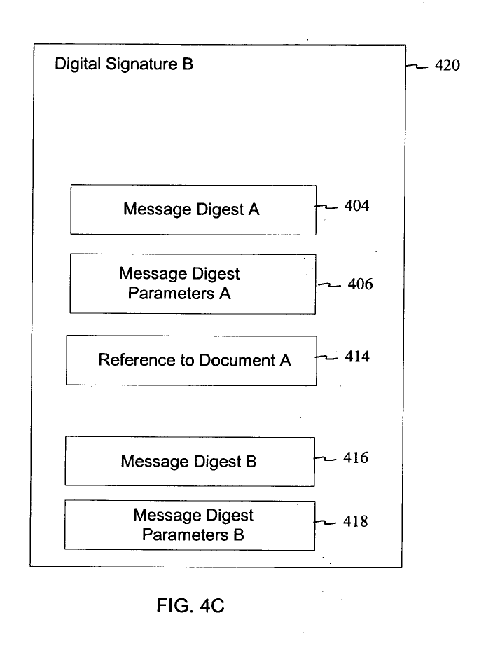

Further details on digital signatures and their use in varying embodiments of the invention are provided below with reference to FIGS. 4A, 4B, 5 and 6.

FIG. 3A is a block diagram illustrating a document file 300 used in example embodiments of the invention. The body portion 304 of document file 300 may include text data, graphics data, video data, audio data, or any combination of the aforementioned data.

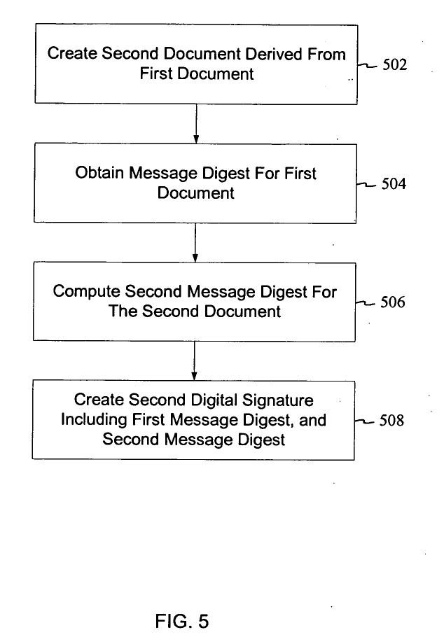

File 300 may include a digital signature 402 designed to detect that a file has been altered subsequent to the creation of the digital signature. In some embodiments, the digital signature 402 includes a message digest value that may be computed using portions or all of a document body. The message digest value is typically a one-way hashing function computed using the objects in the document body, or in the content of the document itself. Further details on the calculations of the message digest value are provided below with reference to FIG. 5.

FIG. 3B is a block diagram illustrating elements of a document 310 following a document update or derivation resulting in body 312 used in example embodiments of the invention. The updated document may be referred to as an electronically derivative work because it is derived from an original or previous document and is electronically processed and stored.

After each modification or update, a new digital signature 410 may be determined using the original document and the various updates that have occurred. Further details on creating the new digital signature are provided below with reference to FIGS. 4B and 5.

FIGS. 3A and 3B illustrate example embodiments in which a digital signature is embedded within a document. FIG. 3C is a block diagram illustrating a document format according to alternative embodiments of the invention. As illustrated in FIG. 3C, a digital signature 410 may be included as an additional block of data appended to a document file 320.

As illustrated in FIG. 3D, in further alternative embodiments, a digital signature 410 may be provided as a separate digital signature file 324 from document file 322. In order to assist in making digital signature 410 available with document file 322, digital signature file 324 may be included in a document package 326 along with document file 322. For example, the document file 322 and the digital signature file 324 may be provided in a file package such as a “.zip” file. The format of “.zip” files is specified in “ZIP File Format Specification”, version: 6.2.1, published by PKWARE Inc. of Milwaukee, Wis. However, the embodiments of the invention are not limited to any particular file packaging application.

FIG. 4A is a block diagram providing further details regarding a digital signature 402 according to an example embodiment. In some embodiments, digital signature 402 includes a message digest 404, and may also include message digest parameters 406. Message digest 404 may be a value that is calculated using all or various portions of a document. In some embodiments, message digest 404 may be a value calculated using a hashing function applied to all or various portions of the document. It is desirable that the hashing function be designed such that it is highly unlikely that two different documents will produce the same hash value. Further, it is desirable that the hashing function used be a one-way hashing function, that is, a hashing function that produces a value in a manner that is extremely hard to reverse engineer. An example of such a hashing function used in some embodiments is the MD5 algorithm as described in Internet RFC 1321, “The MD5 Message-Digest Algorithm” published by the Internet Engineering Task Force (IETF). Alternative embodiments may use the SHA1 (Secure Hashing Algorithm) as defined in Internet RFC 3174 published by the IETF. However, the embodiments are not limited to any particular hashing and message digest function and alternative mechanisms may be used and are within the scope of the embodiments.

In some embodiments, the digital signature 402 may include message digest parameters that indicate the ranges or portions of the document used to generate the message digest value. Other parameters may include an identification of the hashing function used to create the message digest.

FIG. 4B is a block diagram illustrating a digital signature 410 for a derived document according to an example embodiment. In some embodiments, the digital signature for a derived document includes the original digital signature 402, a reference 414 to the original document, a message digest 416 for the derived document, and optionally message digest parameters 418 for the derived document.

Reference 414 comprises a reference to the original document associated with digital signature 402. In some embodiments, the reference may include identification of the original message body 304. In alternative embodiments, the reference may be to an original document stored in a file along with the derived document. In further alternative embodiments, the reference may be a link or path name to a file on a file system. For example, the reference may be specified as a URL (Uniform Resource Locator).

Digital signature 402 comprises a digital signature for the original or previous file. Digital signature 402 may be obtained as part of the original file, as a file associated with the original file, or it may be generated if no digital signature was initially established for the original or previous file.

Second message digest 416 comprises a message digest that may be computed using a hashing function over the derived document contents. The same hashing algorithm may be used as was used in to generate the original message digest 404, including the MD5, SHA1 and other hashing algorithms. In those embodiments where a document is physically derived (e.g. an updated document), the hashing function may be applied to the original document objects in body 304 that remain unchanged along with the updated document objects to produce a new message digest value for the derived document.

Derived message digest parameters 418, like message digest parameters 406 may include identification of portions of the derived document that were included in the creation of the message digest and/or the algorithm used to create the message digest.

The derived digital signature 410 illustrated in FIG. 4B shows a signature for a derived document that was based on one previous document Those of skill in the art will appreciate that a document may have a chain including multiple previous documents, and that the digital signature created as a result of these derivations will include nested digital signatures from the previous documents.

FIG. 4C is a block diagram illustrating a digital signature 420 for a derived document according to an alternative example embodiment. In some embodiments, the digital signature for a derived document includes a message digest 404 for the original or previous document, message digest parameters 406 for the original or previous document, a reference 414 to the original document, a message digest 416 for the derived document, and optionally message digest parameters 418 for the derived document.

Each of the elements included in the digital signature 420 for a derived document are the same or similar to that described above in FIG. 4B. However, the embodiments utilizing digital signature 420 do not obtain or generate a digital signature 402 for an original or previous document. Thus entities receiving the derived document will typically trust that the application generating digital signature 420 used a valid copy of the previous or original document.

The derived digital signature 420 illustrated in FIG. 4C shows a signature for a derived document that was based on one previous document. Those of skill in the art will appreciate that a document may be derived from a chain including multiple previous documents, and that the digital signature created as a result of these derivations may include message digests and optionally message digest parameters for an arbitrary number of previous documents.

The digital signatures illustrated in FIGS. 4A-4C may be used to allow a subsequent receiver of the derived document to determine if either the derived document or a previous and related document have changed. In some embodiments, the digital signatures comprise a digital certificate that is encrypted with the originator's private key. The certificate can then be decrypted using the originator's public key. As long as the private key has not been compromised the certificate will not decrypt correctly unless the corresponding public key is used. Therefore the subsequent receiver will know who computed the original message digest and the derived document message digest.

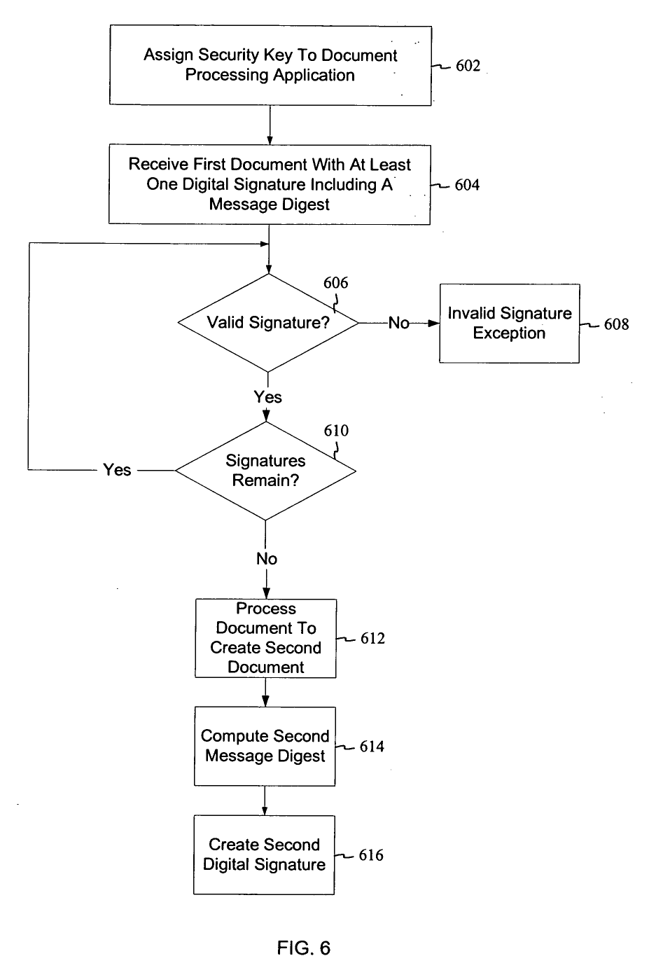

FIGS. 5 and 6 are flowcharts illustrating methods for creating and using digital signatures according to embodiments of the invention. The methods to be performed by the operating environment constitute computer programs made up of computer-executable instructions. Describing the methods by reference to a flowchart enables one skilled in the art to develop such programs including such instructions to carry out the method on suitable processors (the processor or processors of the computer executing the instructions from computer-readable media). The methods illustrated in FIGS. 5 and 6 are inclusive of acts that may be taken by an operating environment executing an exemplary embodiment of the invention.

FIG. 5 is a flowchart illustrating a method for creating a digital signature according to embodiments of the invention. The method begins with creating a second document derived from a first document (block 502). The second document may be created as a result of a user editing the first document. Alternatively, the second document may be created as a result of automated processing applied to the first document. Examples of such automated processing include reading data from the first document used to create the second document, flattening forms in the document, language translation, format conversions for distribution or publishing etc.

The system then obtains a message digest for the first document (block 504). In some embodiments, the system obtains a message digest for the first document from the first document itself (e.g. an embedded message digest) or from a digital signature file associated with the first document.

In alternative embodiments, the system may generate a message digest for the first document. This may be desirable in cases where the document originator did not include a message digest, and the creator of the derived document desires to insure that the derived document is based on an unchanged original or previous document. If generating a message digest, the system applies a hashing function to the bytes comprising the first digital signature to create the signature message-digest. As noted above, various hashing functions may be used, including MD5 and SHA1 based algorithms.

Next, the system computes a second message digest for the second (i.e. derived) document (block 506). The system applies a hashing function to the bytes comprising the derived document to compute the second message digest. Again, various hashing functions may be used, including MD5 and SHA1. In addition, the hashing function used may be different from that used to create the first message digest or the signature message digest.

The system then creates a digital signature by encrypting the first message digest, and the second message digest (block 508). In some embodiments, the digital signature includes a digital signature for the original or previous document, which will include the first message digest. The digital signature may include encryption of other elements, such as a reference to the first document and message digest parameters. Various types of keys may be used to perform the encryption. In some embodiments, a private key from a public/private key pair may be used. In alternative embodiments, a password based key may be used. In further alternative embodiments, a biometric based key such as a scanned fingerprint may be used. The digital signature may then be included as part of the derived document.

FIG. 6 is a flowchart illustrating a method for validating the integrity of a document according to embodiments of the invention. The method begins by assigning a security key to a particular type of document processing application (block 602). For example, one key may be assigned to a document creation application, while another key may be assigned to a forms application, and yet another key to an image processing application. The key may be based on a public/private key pair. However, the embodiments of the invention are not limited to a particular type of key, and other types of keys such as password based keys may be used in alternative embodiments.

The document processing application is operable to receive a first document that has at least one digital signature including a message digest (block 604).

The system then proceeds to determine if the digital signature is valid (block 606). The system decrypts the digital signature to obtain the message digest value, and then applies the same hashing function to the received document to compare the result to the message digest value. If the result and the message digest value match, the system determines that the document has not been altered.

However, if the values do not match, the document has been altered and the system may execute an invalid signature exception (block 608). The system may log the fact that the document has been altered; it may alert an operator or user that the document has been altered; or the system may merely display a diagnostic message indicating the altered document.

If the message digest value indicates the document has not been altered, the system then determines if additional digital signatures associated with previous versions of the document remain (block 610).

If additional signatures remain, for example signatures nested as described in FIG. 3B, the system proceeds to block 610 to decrypt the nested digital signature to obtain a message digest associated with the previous document and determines the contents of the previous document associated with the nested digital signature. Optionally, after obtaining the previous document the hash is computed over that document and compared with the hash provided in the digital signature for that document. This comparison may be used to verify the integrity of the previous document.

In some cases the previous document may not be accessible and this processing step will not be performed at this time. However, in a later audit step the previous document may be accessible and the comparison of the hashes can be done at that time.

The document processing application may then proceed to create a second or derived document (block 612). As discussed above, the derived document may be logically derived or physically derived from the first document. The embodiments of the invention are not limited to any particular form of derivation.

The system the proceeds to create a second message digest for the second or derived document (block 614). In some embodiments, a hashing function such as the MD5 or SHA1 hashing functions may be used to create the second message digest.

The system then creates a digital signature using the second message digest (block 616). The system uses the security key assigned at block 602 to encrypt the message digest and create the second digital signature.

In some embodiments, the second digital signature may be created as described above with reference to FIG. 3B and FIG. 5, with previous digital signatures associated with previous versions of the document included as part of the second digital signature.

In some embodiments, a digital signature may be added by a trusted application that processes one or more documents to produce derived documents. In this case, the use of an application assigned security key to provide the digital signature in the document serves as an indication to subsequent document receivers or users that the document and previous versions of the document were not altered up until the point in time where the trusted application processed the previous document and applied a digital signature to the derived document. In some embodiments, this can be assured because the application may verify the integrity of the previous document or documents using the previous keys found in the documents. For example, in some embodiments, the trusted application computes the hash on a document and compares it to the hash value stored in the document. If the hash values match, the integrity of the previous document is verified.

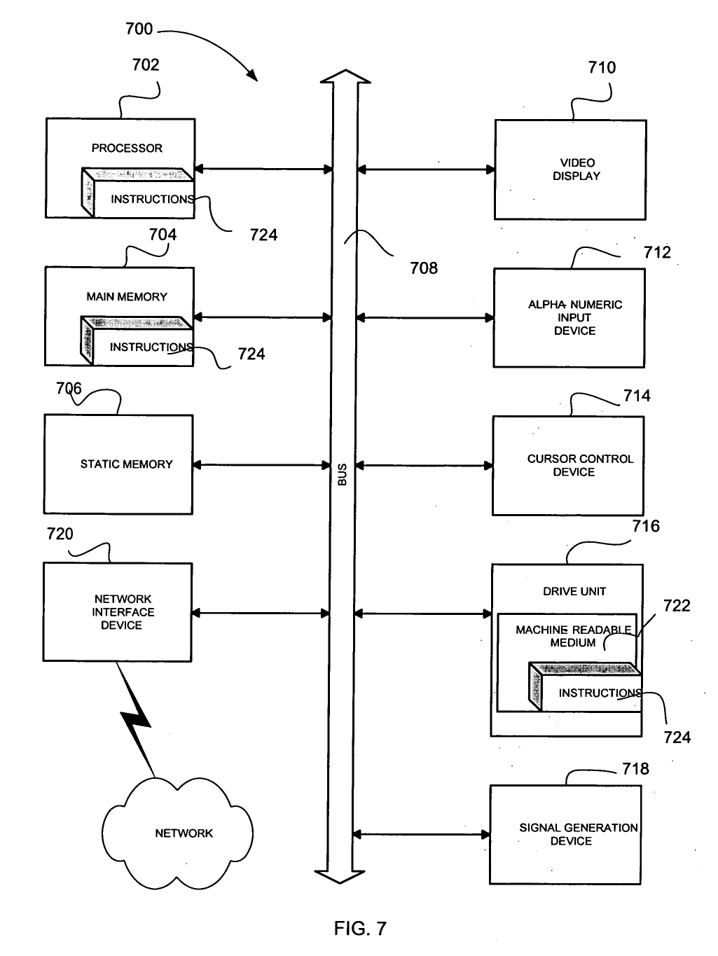

FIG. 7 is a block diagram illustrating major components of a computer system 700 within which a set of instructions, for causing the machine to perform any one or more of the methodologies discussed herein, may be executed. In alternative embodiments, the machines operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720. The network 726 may be any type of wired or wireless network and the network interface 720 may vary based on the type of network. In some embodiments, the network comprises a LAN (local area network). In alternative embodiments, the network may be a wide area network, a corporate network, or an intranet linking multiple networks. In further alternative embodiments, the network may comprise the Internet.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals, including optical and electromagnetic signals.

Systems and methods to protect the integrity of derivative electronic works have been described. Although the present invention has been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. Many other embodiments will be apparent to those of skill in the art upon reviewing the above description. Therefore, it is manifestly intended that this invention be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

What is claimed is:

1. A method comprising:
creating a second document, the second document being derived from a first document;
determining a first message digest for the first document;
computing a second message digest for the second document; and
creating a digital signature for the second document, the digital signature including the first message digest, and the second message digest.

2. The method of claim 1, wherein determining the first message digest includes computing the first message digest.

3. The method of claim 1, wherein determining the first message digest includes obtaining the first message digest from a first digital signature associated with the first document.

4. The method of claim 1, wherein the second message digest includes a reference to the first document.

5. The method of claim 1, wherein the first message digest and the second message digest are computed using a one-way hashing function.

6. The method of claim 5, wherein the one-way hashing function is selected from the group consisting of a checksum, an MD5 hashing algorithm, and an SHA1 hashing algorithm.

7. The method of claim 1, further comprising:
assigning a security key to a document processing software application; and
utilizing the security key to create the digital signature for the second document.

8. The method of claim 1, further comprising verifying an integrity of the first document.

9. The method of claim 8, wherein verifying the integrity of the first document includes determining a computed message digest for the first document and comparing the computed message digest to the first message digest.

10. A method comprising:
assigning an application security key to a document processing application;
receiving, by the document processing application, a first document, the first document containing one or more digital signatures, each digital signature having a message digest associated with a related document;
creating, by the document processing application, a second document derived from the first document;
computing a second message digest for the second document; and
creating a second digital signature including the second message digest using the application security key.

11. The method of claim 10, wherein the second digital signature further includes the one or more digital signatures.

12. The method of claim 10, further comprising verifying, by the document processing application, an integrity for the related document using the message digest in the digital signature associated with the related document.

13. The method of claim 12, wherein verifying the integrity of the related document includes determining a computed message digest for the related document and comparing the computed message digest to the message digest in the digital signature associated with the related document.

14. The method of claim 10, wherein the application security key comprises a private key of a public/private key pair.

15. A computer-readable medium having a data structure encoded thereon, the data structure comprising:
a digital signature including:
a first message digest associated with a first document;
a reference to the first document; and
a second message digest associated with a second document, the second document being derived from the first document.

16. The computer-readable medium of claim 15, wherein the digital signature includes a first digital signature encapsulating the first message digest.

17. An apparatus comprising:
a document parser to parse a first document;
a document modification component to modify the first document to create a derived document;
a modification detection component to:
obtain a message digest associated with the first document;
generate a second message digest associated with the derived document; and
generate a digital signature including the first message digest and the second message digest; and
a document write component to write the derived document and second digital signature.

18. The apparatus of claim 17, wherein the modification detection component includes a hashing function.

19. The apparatus of claim 18, wherein the hashing function conforms to an MD5 algorithm.

20. A machine-readable medium embodying a set of instructions that, when executed by a machine, cause the machine to perform a method comprising:
creating a second document, the second document being derived from a first document;
determining a first message digest for the first document;
computing a second message digest for the second document; and
creating a digital signature for the second document, the digital signature including the first message digest, and the second message digest.

21. An apparatus comprising:
first means for parsing a first document into a derived document;
second means for modifying the first document;
third means for:
generating a first message digest associated with the first document;
generating a second message digest associated with the derived document; and
generating a digital signature including the first message digest, a reference to the first document and the second message digest, and
fourth means for writing the derived document and second digital signature.
